(19) United States
(12) Patent Application Publication
(10) Pub. No.: US 2026/0274490 A1
(43) Pub. Date: Sep. 17, 2026

(54) A METHOD FOR PRODUCING A WEB OF PACKAGING MATERIAL AND AN APPARATUS THEREOF

(71) Applicant: TETRA LAVAL HOLDINGS & FINANCE S.A., Pully (CH)

(72) Inventors: Daniele BULGARELLI, Modena (IT); Sara EGIDI, Modena (IT); Paolo SCARABELLI, Modena (IT); Davide BORGHI, Modena (IT); Davide CLO', Modena (IT)

(21) Appl. No.: 19/471,335

(22) PCT Filed: Apr. 9, 2024
(86) PCT No.: PCT/EP2024/059564

§ 371 Date: Sep. 30, 2025

(30) Foreign Application Priority Data
Apr. 17, 2023 (IT) 102023000007422

(51) Int. Cl. B65B 61/02; B41F 5/04; B41F 5/24; B41F 13/08; B41F 13/54; B41M 1/04; B65B 41/12; B65B 41/18; B65B 57/04

(52) U.S. Cl. CPC B65B 61/025; B41F 5/04; B41F 5/24; B41F 13/08; B41F 13/54; B41M 1/04; B65B 41/12; B65B 41/18; B65B 57/04

(57) ABSTRACT

A method (S100) for producing a web (118) of packaging material is disclosed. The method (S100) comprises providing (S102) a carton-based web provided with a first side (120) and a second side (122), and printing (S104) decors (200a-b) on the first side (120) of the carton-based web by using a printing plate cylinder (112) having at least two subsequently placed printing plates (114a-d) attached thereto, wherein the at least two printing plates (114a-d) have different printing patterns (202a-b) such that sequences (206a-b) of sections (204a-c) of the web (118) with different decors (200a-b) are provided, wherein each section of the web (118) is arranged to be transformed into a package (500) filled with food product in a roll-fed filling machine (600).

### TECHNICAL FIELD

The invention relates to packaging technology. More particularly, it is related to methods and systems for tracing a web of packaging material in a roll-fed packaging machine.

### BACKGROUND ART

Today, roll-fed packaging machines are well known within the food industry. For instance, Tetra Pak Brik™ machines marketed by Tetra Pak™ are commonly used in milk and juice food production lines. The roll-fed packaging concept is however not only used for carton packages, but also for packages made of other material, such as plastics or other polyethylene-alike materials.

The roll-fed packaging machine, as defined herein, receives a reel of packaging material, and unwinds the packaging material such that a web is formed. To avoid that the machine has to be stopped due to that the reel has to be replaced by a new reel, so-called automatic splicing may be used, that is, packaging material of the new reel is connected to the packaging material of the reel. By doing so, continuous operation of the machine can be obtained. For food packaging machine this is of particular relevance since a start-up of the machine has to follow a strict scheme to assure that food safety is not compromised.

The packaging material received by the packaging machine is provided with décor. This décor is usually printed by using flexographic printing or off-set printing technology, but for smaller series it may also be an option to use digital printing. If using digital printing, either for printing an entire décor of the packages or only part of the décor, it is made possible to add package identifiers, such as QR codes, to the packages. The possibility to provide package identifiers comes with a number of advantages. For instance, traceability is facilitated. By being able to identify the package at any point of time with a reader, e.g. a QR reader app in a mobile phone, it is made possible to know when and where the package was produced. To reduce the waste typically linked to re-calls, which may be triggered by that for some reason the food product filled into the packages did not fulfill quality standards, the packages concerned can be pinpointed in a precise manner. An effect of this increased precision is that less packages need to be discarded, which is beneficial both from an economical as well as environmental standpoint.

Even though the use of package identifiers, such as QR codes, have been used to enable improved traceability, the improved traceability comes with an additional cost. By having each package printed individually, either in full or in part, e.g. by having parts of the décor provided by flexographic printing, and parts by digital printing, it is required additional equipment compared to the today's commonly used approach of flexographic printing. Due to the additional costs, packages with package identifiers are today only produced in minor quantities.

### SUMMARY

It is an object of the invention to at least partly overcome one or more of the above-identified limitations of the prior art. In particular, it is an object to provide a method to prevent that a package is related to data belonging to another package due to misalignment of the web inside the machine.

According to a first aspect it is provided a method for producing a web of packaging material. The method may comprise providing a carton-based web provided with a first side and a second side, and printing décors on the first side of the carton-based web by using a printing plate cylinder having at least two subsequently placed printing plates attached thereto, wherein the at least two printing plates have different printing patterns such that sequences of sections of the web with different décors are provided, wherein each section of the web is arranged to be transformed into a package filled with food product in a roll-fed filling machine.

An advantage with having consecutive sections of the web provided with different décors is that in case the tracing of the web is misaligned, a shift, being a result of the misalignment, can be detected due to the different décors and, once a deviation is detected, this can be compensated for. As a result, an improved reliability of the tracing of the web in the packaging machine can be achieved.

Having printing plates with different printing patterns on the printing plate cylinder is more cost efficient than having individual printing of each sections, which may be made with, by way example, digital printing technology.

The method may further comprise rolling up the printed web on a reel, wherein the reel may be provided with an electronic device comprising a transceiver, a memory and a processor, and uploading web-related data comprising information about a number of sections for each sequence of the décors to the electronic device, such as an RFID tag, provided on the reel.

By having information stored on the electronic device provided on the reel, information regarding how frequently the décors are occurring on the web can be provided. In this way, settings can be adjusted automatically. In addition, even if the packaging machine is not connected to a remote server, this information can be provided to the packaging machine. Providing for that the information can be provided to the packaging machine automatically also reduces the risk for incorrect settings.

The different printing patterns may comprise different two-dimensional codes.

By having only the two-dimensional codes being different, the décors may look the same apart from the two-dimensional codes.

The different two-dimensional codes may constitute different DataMatrix codes.

An advantage with using DataMatrix codes is that these can be read quickly and accurately.

The method may further comprise providing weakening lines in the web according to a weakening lines pattern by compressing a carton layer of the packaging material such that folding of the web into the packages can be facilitated, wherein the different two-dimensional codes are placed with respect to the weakening lines pattern such that once the web is folded into the packages the different two-dimensional codes are protected by flaps of the packages.

By having the codes provided underneath the flaps, the risk of having these codes scratched or in any other way deteriorated such that these cannot be read can be reduced.

According to a second aspect it is provided a method for operating a roll-fed packaging machine by using a computer system. The method may comprise receiving a reel with a web of packaging material, wherein said web may comprise sequences of sections of the web with different décors printed according to the method according to the first aspect, unrolling the web from the reel, feeding the web by using a web feeding arrangement, tracing the web by estimating a position of the web based on the control data provided to the web feeding arrangement, compensating for tracing errors by determining, downstream a web buffer station, a control data-based position of the web based on the control data provided to the web feeding arrangement, registering, downstream the web buffer station, the different décors of the sections of the web by using an image capturing device (640a-e), said image capturing device positioned in a position along a web path placed downstream the web buffer station, identifying a deviation between the control-data based position of the web and the different décors registered by the image capturing device, adjusting the control-data based position in view of the deviation identified.

By having the web printed as explained above with respect to the first aspect, in case there is a tracing error during the operation of the packaging machine, this tracing error can be identified by using the image capturing devices. Once the deviation is identified, this can be compensated for, thereby achieving a more reliable tracing of the web throughout the packaging machine. In other words, the position of the web can be determined more accurately.

The method may further comprise downloading data from an electronic device on the reel, said data comprising information about the number of sections per sequence of the web.

By having the information of the number of sections per sequence provided in this way, this information can be transferred from the reel to the packaging machine automatically, thereby reducing the risk of having incorrect data entered.

The different décors may comprise different two-dimensional codes.

The different two-dimensional codes may constitute different DataMatrix codes.

The web buffer station may be provided upstream and/or downstream an automatic splicing unit (ASU) and/or upstream and/or downstream an injection molding station for molding opening devices on the web.

An advantage of having the ASU is that the reel with packaging material can be replaced without stopping the packaging machine. By using the methods and apparatuses suggested herein, a potential risk of having tracing errors as an effect of the web buffer stations used in combination with the ASU can be mitigated.

The injection molding station, which may be used for providing opening devices onto the web, most often requires an indexed movement, that is, the web ought to be stopped during the molding. To mitigate that this indexed movement may result in that tracing errors occur, due to the use of web buffer stations, using the sections with different décors as described above can be used for mitigating this.

According to a third aspect it is provided a printing plate cylinder for printing décors onto a web of packaging material. The printing plate cylinder may comprise at least two printing plates, wherein each printing plate may have different printing patterns such that sequences of sections of the web with different décors can be provided, wherein each section of the web may be arranged to be transformed into a package filled with food product in a roll-fed filling machine such that tracing errors of the web inside the packaging machine can be compensated for.

As described above with respect to the first and second aspect, by using the printing plate cylinder and having plates with different printing patterns, cost-efficient printing can be achieved while at the same time possible tracing errors inside the packaging machine can be identified and compensated for.

The different printing patterns may comprise different two-dimensional codes.

According to a fourth aspect it is provided a packaging machine comprising a reel receiver arranged to receive a reel holding a web of packaging material, wherein the web may comprise sequences of sections of the web with different décors, a web feeding arrangement arranged to feed the web inside the packaging machine along a web path, a web buffer station arranged to hold part of the web for a period of time to compensate for planned or unplanned stops in the web path, an image capturing device placed downstream the web buffer station, said image capturing device being arranged to register the different décors of the sections of the web, and a computer system arranged to control the web feeding arrangement by using control data, to trace the web by estimating a control data-based position of the web by using the control data, to identify a deviation between the control-data based position of the web and the different décors registered by the image capturing device, and to adjust the control-data based position such that the deviation is compensated for.

The same features and advantages as described above with respect to any of the other aspects also apply to this aspect.

The packaging machine may further comprise an electronic device reader configured to retrieve data from an electronic device provided on the reel, wherein the data comprises information about the number of sections per sequence.

According to a fifth aspect it is provided a control circuity comprising a processor, a memory and a transceiver, said processor being arranged to, in response to control data for a web feeding arrangement in a packaging machine, estimate a control data-based position for a section of the web downstream a web buffer station, in response to registered different décors captured by an image capturing device placed in a position of a web path downstream the web buffer station, identify a deviation between the control-data based position and a décor-based position determined based on the different décors registered by the image capturing device, and in case the deviation is found, adjust the tracing of the web by compensating for the deviation identified.

The same features and advantages as described above with respect to the other aspects also apply to this aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a general illustration of a process for printing décors onto a web of packaging material.

FIG. 2 illustrates how sequences with sections with different décors can be printed onto the web.

FIG. 3 illustrates an example of a section with weakening lines in further detail.

FIG. 4 illustrates an example of the section after this has been filled and sealed, herein referred to as intermediate product.

FIG. 5 illustrates the example of FIG. 4 after this has been folded into a package.

FIG. 6 generally illustrates a packaging machine.

FIG. 7 is a flowchart illustrating a method for producing a web.

FIG. 8 is a flowchart illustrating a method for operating a roll-fed packaging machine.

FIG. 9 illustrates a control circuitry.

### DETAILED DESCRIPTION

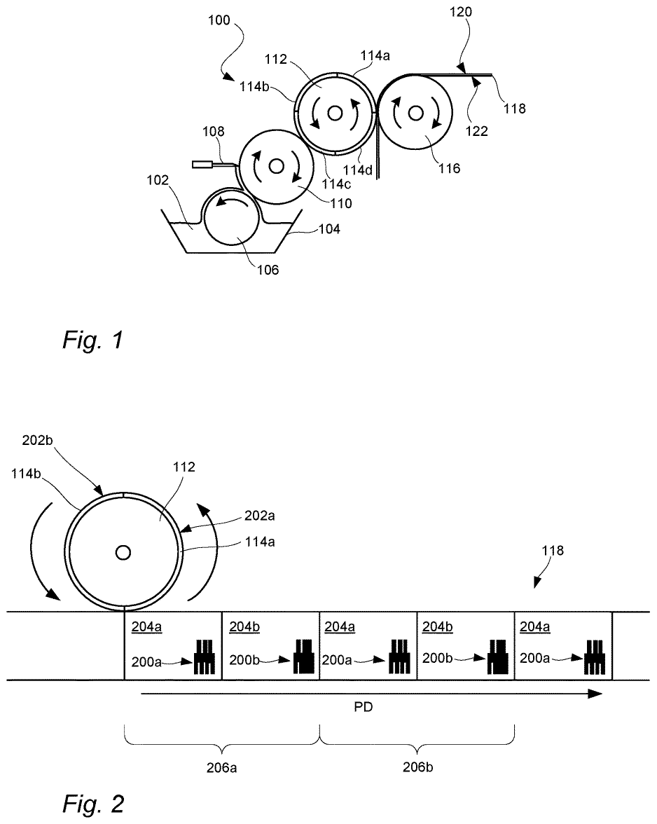

With reference to FIG. 1. a printing system 100 is illustrated. As illustrated, ink 102 may be provided in an ink tray 104. By using a fountain roller 106, the ink 104 may be fed from the ink tray 104 to an anilox roller 110. Excessive ink 104 may be removed by using a doctor blade 108. From the anilox roller 110, the ink 104 can be transferred to a plate cylinder 112 having a number of printing plates 114a-d attached thereto. In the example illustrated, four printing plates 114a-d are applied. By using the printing plates 114a-d and the plate cylinder 112 in combination with an impression cylinder 116, a web 118 of packaging material may be printed. As illustrated, a first side 120 of the web 118 may be printed. The first side 120 of the web 118 can at a later stage form and outside of a package, that is, facing an outside environment, while a second side 122 of the web 118 can comprise an inside of the package, that is, facing a food product. The printing system 100 may be using so-called flexography, but any other printing system using one or several plate cylinders 112 with printing plates 114a-d may be used.

FIG. 2 illustrates another example of the plate cylinder 112. In this example, the plate cylinder is provided with two printing plates 114a-b. As illustrated, different décors 200a-b may be provided as an effect of that different printing patterns 202a-b are used on the printing plates 114a-b. In this example, the décors 200a-b are simple décors only depicting two-dimensional codes. It is however possible to provide more complex décors. If having more complex décors, such as images, brand name, product information etc, the different décors 200a-b may differ only in that different two-dimensional codes are provided.

As illustrated, if having two different printing plates 114a-b with different printing patterns 202a-b, every other section 204a-b of the web 118 being printed is provided with the same décor 200a-b. In this way, sequences 206a-b of sections 204a-b with different décors 200a-b are provided. An advantage with this is, as will be described in further detail below, that in case there is a tracing error shifting the web by one section 204a-b this can be detected by using image capturing devices arranged to read the different décors of the different sections. In case more than two sections per sequence are provided, shifts of more than one section can be detected.

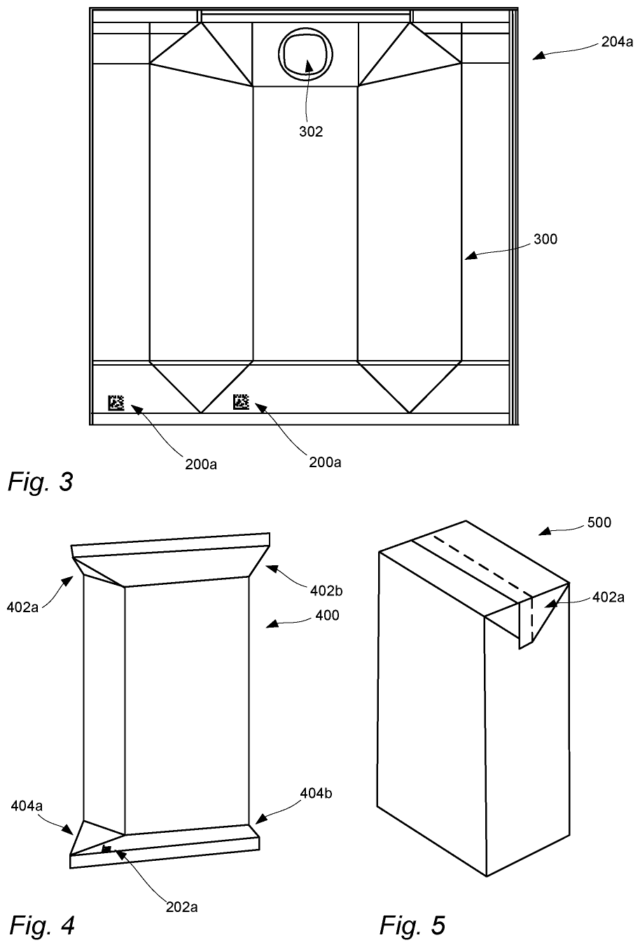

FIG. 3 illustrates an example of the section 204a in further detail. Unlike the examples provided in FIG. 2, the section 204a illustrated in FIG. 3 is provided with weakening lines. Having the weakening lines facilitates folding of the section 204a into a package once this is sealed and filled. In addition to the weakening lines 300, a pre-laminated hold (PLH) 302 may be provided. An opening device may be injection molded onto the PLH 302 in the packaging machine. Another option is to have the opening device pre-applied, that is, applied onto the section 204a before this is filled or sealed. Still an option is to have the opening device post-applied, that is, having the opening device applied onto the package after this has been filled, sealed and folded.

As illustrated, the décor 200a may constitute one or several two-dimensional codes. The two-dimensional codes may be placed on a bottom panel or on a bottom flap. An advantage of having the two-dimensional code placed on the bottom panel or on the bottom flap is that the code can be less exposed to wear compared to if having the code provided on a top panel or a side panel. In case the code is provided on the bottom panel or on the bottom panel close to the bottom panel, the code may be covered by the bottom panel when this is folded inwards during the final forming of the package. Having the code covered in this manner may further reduce wear effects, thereby reducing the risk that the code cannot be read due to the handling of the package.

FIG. 4 illustrates an intermediate product 400 being the section 204a after this has been filled with food product and sealed, but before folded into its final form. As discussed above, the code or other element of the décor 200a distinguishing the section 204a from another section 204b of the sequences 206a-b may be placed such that this is protected by bottom flaps 404a-b. Still an option, even though not illustrated, is that the code is protected by top flaps 402a-b. Even though only one code is illustrated in FIG. 4, several codes placed in different locations of the section 204a may be provided.

FIG. 5 illustrates a package 500, being the intermediate product 400 after this has been folded along the weakening lines 300. To provide for that the top flaps 402a-b or the bottom flaps 404a-b are kept in position, glue may be applied. The example provided in FIGS. 4 and 5 is a brick-shaped package. Other examples may also be used, e.g. wedge-shaped packages or brick-shaped packages with a slanted top surface.

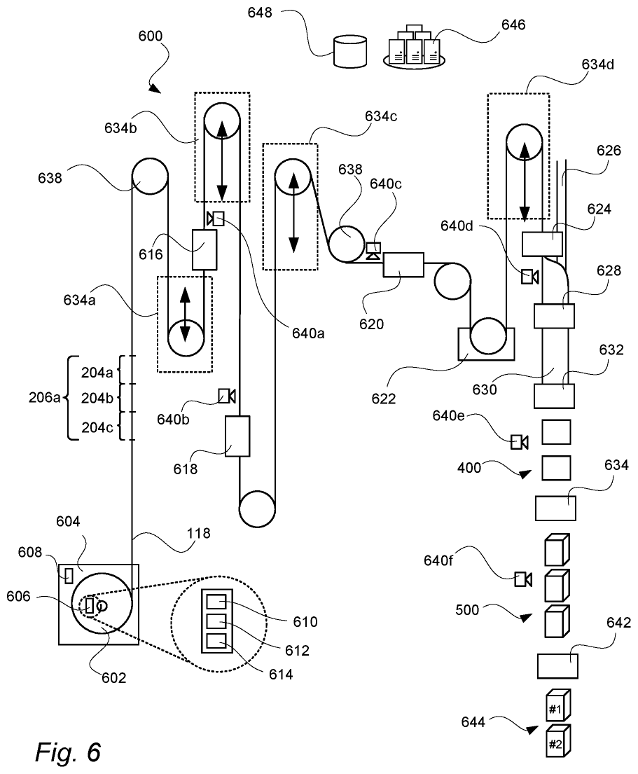

FIG. 6 generally illustrates by way of example a packaging machine 600. The web 118 of packaging material printed according to the process described above and illustrated in FIGS. 1 and 2, or any other similar process, is provided via the reel 602. The reel 602 can be received via reel receiver 604. After being unrolled from the reel 602, the web 118 and the printed sections 204a-c and the sequences 206a-b, herein exemplified by three sections per sequence, can be fed into the packaging machine 600. An electronic device 606, such as an RFID tag, may be integrated in or provided on the reel 602. An electronic device reader 608 may be provided in the reel receiver 604 such that information can be read from the electronic device 606. Such information may for instance encompass the number of sections per sequence, but also information about the material and how longitudinal and transversal sealing stations in the packaging machine should be set to make sure that the sealing processes is aligned with the packaging material of the web 118. In addition, the information may comprise size of the packages, e.g. 200 ml brick-shaped portion packs, such that the sealing jaws of the transversal sealing station can be adapted accordingly. As illustrated, the electronic device 606 may comprise a processor 610, a memory 612 holding the information, and a transceiver 614 enabling communication.

To avoid machine downtime when switching from one reel of packaging material to another, an automatic splicing unit (ASU) 616 may be provided. By having such unit it is namely made to possible to attach an end edge of the web 118 of a first reel to a start edge of the web 118 of a second reel.

A longitudinal sealing (LS) strip applicator 618 may be provided in case the web 118 comprises a carton layer or any other layer that may be dissolved or in any other way become damaged when in contact with a liquid food product. By having the LS strip applicator 118 a strip of plastics or any other suitable material for food contact that can be attached to one side of the web 118 such that once a tube is formed the strip will cover an inside of the longitudinal sealing such that a carton layer edge is not exposed to the food product.

Further, in case opening devices or similar are to be molded onto the web 118, an injection molding station 620 may form part of the packaging machine 600. The molding station 620 may comprise two molding members provided on each side of the web 118. Once having a cavity between the molding members filled with plastics, or other suitable material for the purpose, the opening devices may be formed. As illustrated in FIG. 3, so-called pre-laminated holes (PLHs) may be provided beforehand to facilitate the molding of the opening devices and/or opening of the packages by consumers.

To make sure that the unwanted microorganisms are killed off, thereby making the food product held in the future package safe to consume, a sterilization station 622 may form part of the packaging machine 600. By way of example, the sterilization station 622 may be a peroxide bath and/or a low voltage electron beam (LVEB) system.

A longitudinal sealing (LS) station 624 may be provided for forming the web 118 into a tube 630. A product filling pipe 626 may be provided such that the tube 630 can be filled with food product. In case the LS strip applicator 618 forms part of the packaging machine, e.g. in case the carton layer is present in the packaging material, the LS station 624 may be arranged to seal side sections of the web 118 together and also to provide for that the longitudinal seal is covered inside the tube by the strip.

Downstream the LS station 624, a tube guiding station 628 may be provided for guiding the tube into a transversal sealing (TS) station 632. The transversal sealing station 632 can be arranged to transversally seal the tube 630 such that a top fin and a bottom fin on consecutive packages are formed at the same time. Further, a knife may be provided to separate the consecutive packages. By way of example, the transversal sealing station may use induction heating or ultrasonic sealing. Each package formed may be based on one section 204a-c. Thus, in case there is a misalignment longitudinally, this may result in that the transversal seals, i.e. the top fin and the bottom fin, are incorrectly placed.

The intermediate products 400, illustrated in FIG. 4, output from the transversal sealing station 632 may be fed into a final folder 634 arranged to fold the intermediate product 400 into the package 500, illustrated in FIG. 5.

As illustrated, when replacing one reel with another, the ASU 616 may be used to avoid that the packaging machine 600 is stopped. However, in addition to having the ASU 616 attaching the web 118 of the first reel to the web 118 of the second reel, at least one web buffer station 634a-b may be provided. By having the web buffer stations 634a-b, the web 118 may be stopped such that attachment of the webs 118 may be achieved with the webs 118 not moving. As illustrated a first web buffer station 634a may be provided upstream the ASU 616 and a second web buffer station 634b may be provided downstream. The first and second web buffer stations 634a-b may comprise a roller that can be translationally moved such that a web path is either extended or reduced.

Just as the ASU 616 may benefit from having the web 118 stopped, this also applies to the injection molding station, e.g. direct injection molding station (DIMC). Instead of moving the molding members with the web 118, it may be more beneficial to have the web 118 moved with indexed movements. Such indexed movements may be achieved by having a third web buffer station 634c placed upstream and a fourth web buffer station 634d placed downstream. The web buffer stations 634a-d may be connected and controlled in combination. By doing so, it is for instance possible to both provide indexed movements for the injection molding station 620 as well as providing for that the transversal seals are placed correctly longitudinally.

A web feeding arrangement 638 may be provided for feeding the web 118 throughout the packaging machine 600. As illustrated, the web feeding arrangement 638 may comprise a number of drive rollers. Based on the configurations and settings of the web feeding arrangement 638, positions of the sections 204a-c can be estimated. More particularly, based on control data provided to the web feeding arrangement 638, the positions of the sections 204a-c of the web 118 can be estimated. For instance, by knowing by which speed driver rollers are set operate and also by which distances different rollers are spaced apart, the positions of the sections 204a-c can be estimated.

As illustrated in FIGS. 2, 3 and 4, the sections 204a-c may comprise different décors 200a-b, e.g. different two-dimensional codes. Image capturing devices 640a-f, e.g. cameras, may be placed downstream the web buffer stations 634a-d. By having the image capturing devices 640a-f, the different décors 200a-b of the sections 204a-c can be detected and in case positions identified via the different décors 200a-b do not match the positions estimated based on the control data, a deviation between the two can be detected and compensated for. Put differently, the positions determined by using the image capturing devices 640a-f can be used for compensating for any tracing errors that may occur when using the control data for tracing the web throughout the packaging machine. By having different décors 200a-b for the sections 204a-c in the sequences 206a-b it is made possible to detect if the position estimated by the control data is shifted one section in case two different décors are used, and in case more than two different décors are used a shift of more than one section can be detected. Once having the deviation detected, the web feeding arrangement 638 can be adjusted accordingly, thereby assuring e.g. that there is no misalignment longitudinally when feeding the tube into the transversal sealing station.

As explained above, the different décors 200a-b, obtained by having the printing plates 114a-d on the plate cylinder 112 provided with different printing patterns 202a-b as illustrated in FIGS. 1 and 2, provides for improved tracing of the web 118 throughout the packaging machine 600. In addition to reducing the risk that e.g. the tube 630 is misaligned longitudinally when being fed into the TS station 632, the improved tracing also provides for that the packages 500, after being fed from the final folder 634, can be provided with package identifiers, sometimes referred to as package IDs. As illustrated, the package identifiers may be printed onto the packages 500 by and ID printer 642. The packages 500 provided with the package identifiers, which may be a QR codes, may be referred to as ID marked packages 644. Unlike the packages 500, which have different décors 200a-b, the ID marked packages 644 may be uniquely identifiable or at least virtually uniquely identifiable.

The web feeding arrangement 638, the image capturing devices 640a-f, the web buffer stations 634a-d as well as other parts of the packaging machine 600 may be communicatively connected to a server 646, or other data processing equipment, herein referred to as computer system, and optionally a database 648. The server 646 and the database 648 may be dedicated to the packaging machine 600, but they may also be shared by several packaging machines 600. When being shared, data collected from the different packaging machines 600 may be used for creating artificial intelligence (AI) based and/or machine learning (ML) based models for how the packaging machines 600 should be adjusted in different situations to mitigate tracing errors.

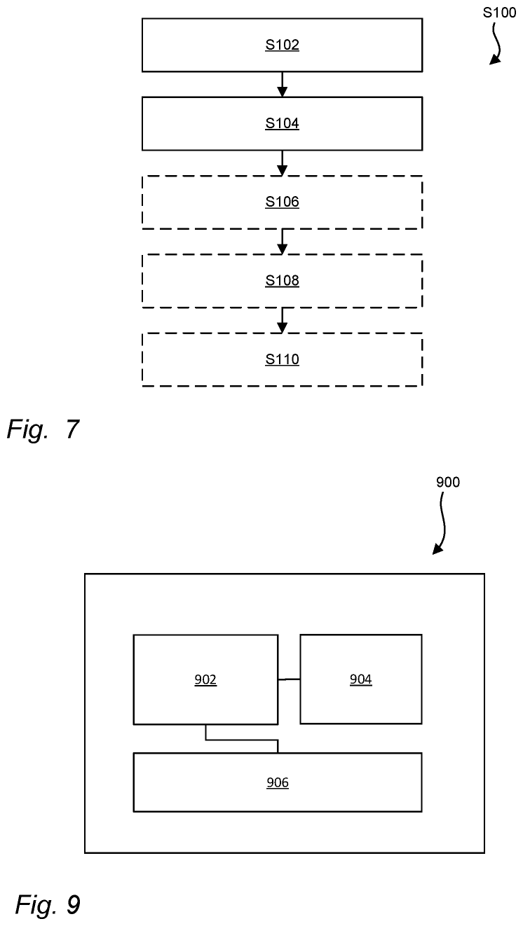

FIG. 7 is a flowchart illustrating a method S100 for producing the web 118 of packaging material. The method can comprise providing S102 a carton-based web with the first side 120 and the second side 122, and printing S104 décors 200a-b on the first side 120 by using the printing plate cylinder 112 having at least two subsequently placed printing plates 114a-d attached thereto, wherein the at least two printing plates 114a-d have different printing patterns 202a-b such that sequences 206a-b of sections 204a-b of the web 118 with different décors 200a-b are provided, wherein each section of the web 118 is arranged to be transformed into a package 500 filled with food product in a roll-fed filling machine 600.

The method S100 may further comprise providing S106 the weakening lines 300 in the web 118 according to a weakening lines pattern by compressing a carton layer of the packaging material such that folding of the web 118 into the packages 500 is facilitated. In case the different décors 200a-b comprise different two-dimensional codes, these may be placed with respect to the weakening lines pattern such that once the web 118 is folded into the packages 500 the different two-dimensional codes are protected by flaps 402a-b, 404a-b of the packages 500.

Further, the method S100 may comprise rolling up S108 the printed web 118 on the reel 602. The reel may be provided with the electronic device 606 comprising the transceiver 614, or other data communication module, the memory 612 and the processor 610, and uploading S110 web-related data comprising information about a number of sections for each sequence of the décors 200a-b to the electronic device 606, such as an RFID tag, provided on the reel 602.

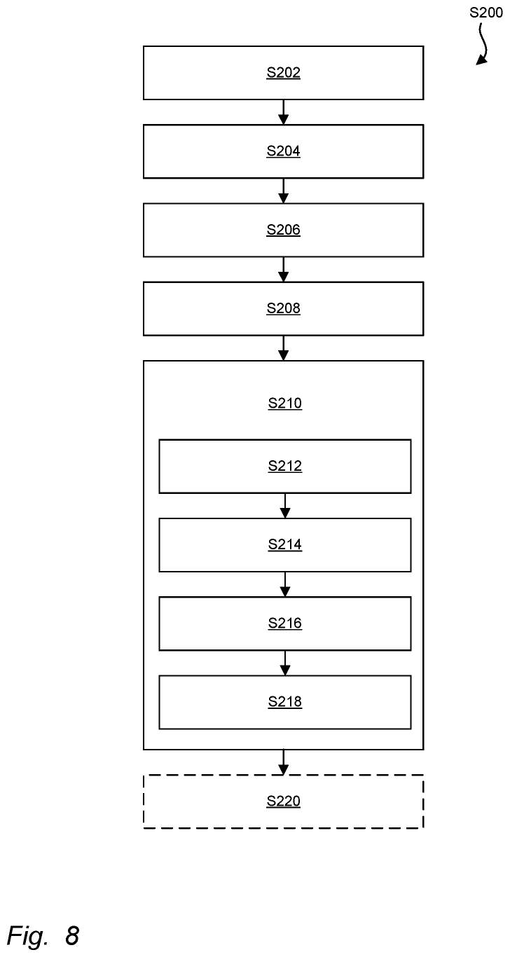

FIG. 8 is a flowchart illustrating a method S200 for operating the roll-fed packaging machine 600 by using a computer system 646. The method may comprise receiving S202 the reel 602 with the web 118 of packaging material, wherein said web 118 may comprise sequences 206a-b of sections 204a-c of the web 118 with different décors 200a-b printed according to the method illustrated by the flowchart of FIG. 7, unrolling S204 the web 118 from the reel 602, feeding S206 the web 118 by using the web feeding arrangement 638, tracing S208 the web 118 by estimating a position of the web 118 based on the control data provided to the web feeding arrangement 638, compensating S210 for tracing errors by determining S212, downstream the web buffer station 636a-d, a control data-based position of the web 118 based on the control data provided to the web feeding arrangement 638, registering S214, downstream the web buffer station 636a-d, the different décors 200a-b of the sections of the web 118 by using the image capturing device 640a-e, said image capturing device positioned in a position along a web path placed downstream the web buffer station 636a-d, identifying S216 the deviation between the control-data based position of the web and the different décors registered by the image capturing device 640a-e, adjusting S218 the control-data based position in view of the deviation identified.

Further, the method may comprise downloading S220 data from the electronic device 606 on the reel 602, said data comprising information about the number of sections 204a-c per sequence 206a-b of the web 118.

FIG. 9 illustrates a control circuitry 900 comprising a processor 902 a memory 904 and a transceiver 906, said processor 902 being arranged to in response to the control data for the web feeding arrangement 638 in the packaging machine 600, estimate the control data-based position for the section 204a-c of the web 118 downstream the web buffer station 636a-d, in response to registered different décors 200a-b captured by the image capturing device 640a-e placed in a position of the web path downstream the web buffer station 636a-d, identify the deviation between the control-data based position and a décor-based position determined based on the different décors 200a-b registered by the image capturing device 640a-e, in case the deviation is found, adjust the tracing of the web by compensating for the deviation identified.

From the description above follows that, although various embodiments of the invention have been described and shown, the invention is not restricted thereto, but may also be embodied in other ways within the scope of the subject-matter defined in the following claims.

1. A method for producing a web of packaging material, said method comprising
providing a carton-based web comprising a first side and a second side, and
printing décors on the first side of the carton-based web by using a printing plate cylinder having at least two subsequently placed printing plates attached thereto, wherein the at least two printing plates comprise different printing patterns such that sequences of sections of the web with different décors are provided, wherein each section of the web is arranged to be transformed into a package filled with food product in a roll-fed filling machine.

2. The method according to claim 1, further comprising:
rolling up the printed web on a reel, wherein the reel is provided with an electronic device comprising a transceiver, a memory and a processor, and
uploading web-related data comprising information about a number of sections for each sequence of the décors to the electronic device, such as an RFID tag, provided on the reel.

3. The method according to claim 1, wherein the different printing patterns comprise different two-dimensional codes.

4. The method according to claim 3, wherein the different two-dimensional codes constitute different DataMatrix codes.

5. The method according to claim 3, further comprising:
providing weakening lines in the web according to a weakening lines pattern by compressing a carton layer of the packaging material such that folding of the web into the packages is facilitated,
wherein the different two-dimensional codes are placed with respect to the weakening lines pattern such that once the web is folded into the packages the different two-dimensional codes are protected by flaps of the packages.

6. A method for operating a roll-fed packaging machine by using a computer system, said method comprising:
receiving a reel with a web of packaging material, wherein said web comprises sequences of sections of the web with different décors printed according to a method according to claim 1,
unrolling the web from the reel,
feeding the web by using a web feeding arrangement,
tracing the web by estimating a position of the web based on the control data provided to the web feeding arrangement,
compensating for tracing errors by
determining, downstream a web buffer station, a control data-based position of the web based on the control data provided to the web feeding arrangement,
registering, downstream the web buffer station, the different décors of the sections of the web by using an image capturing device, said image capturing device positioned in a position along a web path placed downstream the web buffer station, and
identifying a deviation between the control-data based position of the web and the different décors registered by the image capturing device, adjusting the control-data based position in view of the deviation identified.

7. The method according to claim 6, said method further comprising:
downloading data from an electronic device on the reel ,said data comprising information about the number of sections per sequence of the web.

8. The method according to claim 6, wherein the different décors comprise different two-dimensional codes.

9. The method according to claim 8, wherein the different two-dimensional codes constitute different DataMatrix codes.

10. The method according to claim 6, wherein the web buffer station is provided upstream and/or downstream an automatic splicing unit (ASU) and/or upstream and/or downstream an injection molding station for molding opening devices on the web.

11. A printing plate cylinder for printing décors onto a web of packaging material, said printing plate cylinder comprising:
at least two printing plates, wherein each printing plate have different printing patterns such that sequences of sections of the web with different décors are provided, wherein each section of the web is arranged to be transformed into a package filled with food product in a roll-fed filling machine such that tracing errors of the web inside the packaging machine can be compensated for.

12. The printing plate cylinder according to claim 11, wherein the different printing patterns comprise different two-dimensional codes.

13. A packaging machine comprising:
a reel receiver arranged to receive a reel holding a web of packaging material, wherein the web comprises sequences of sections of the web with different décors,
a web feeding arrangement arranged to feed the web inside the packaging machine along a web path,
a web buffer station arranged to hold part of the web for a period of time to compensate for planned or unplanned stops in the web path,
an image capturing device placed downstream the web buffer station, said image capturing device being arranged to register the different décors of the sections of the web, and
a computer system arranged to control the web feeding arrangement by using control data, to trace the web by estimating a control data-based position of the web by using the control data, to identify a deviation between the control-data based position of the web and the different décors registered by the image capturing device, and to adjust the control-data based position such that the deviation is compensated for.

14. The packaging machine according to claim 13, further comprising an electronic device reader configured to retrieve data from an electronic device provided on the reel, wherein the data comprises information about the number of sections per sequence.

15. A control circuity comprising a processor, a memory and a transceiver, said processor being arranged to:
in response to control data for a web feeding arrangement in a packaging machine, estimate a control data-based position for a section of the web downstream a web buffer station,
in response to registered different décors captured by an image capturing device placed in a position of a web path downstream the web buffer station, identify a deviation between the control-data based position and a décor-based position determined based on the different décors registered by the image capturing device, and
in case the deviation is found, adjust the tracing of the web by compensating for the deviation identified.
